(19) United States
(12) Patent Application Publication
(10) Pub. No.: US 2004/0012531 A1
(43) Pub. Date: Jan. 22, 2004

(54) Mobile terminal device

(75) Inventor: Yasushi Toda, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/617,237

(22) Filed: Jul. 11, 2003

(30) Foreign Application Priority Data
Jul. 17, 2002 (JP) 208563/2002

(51) Int. Cl. H01Q 1/24

(52) U.S. Cl. 343/702

(57) ABSTRACT

A folding cellular phone includes an antenna to which a depression switch and a rotation switch are connected. A user can allow the cellular phone in a folded state to execute a predetermined operation by operating a tip portion of the antenna. For example, it is made possible to display a menu on a second display unit or to issue an alarm signal by pressing and rotating operations for the tip portion.

### BACKGROUND OF THE INVENTION

1. Field of the Invention

The present invention relates to a mobile terminal device, and more particularly to a mobile terminal device which is excellent in ease of operation and is not operated by an operation of another person.

2. Description of the Related Prior Art

In recent years, various types of cellular phones have been utilized. For example, there are listed a folding cellular phone provided with two casings, a straight cellular phone provided with one casing, a flip cellular phone provided with a flip covering an operating unit, and the like. Particularly, in the case where the folding cellular phone is folded, a user cannot operate an operating unit provided on an inner surface of a casing thereof. In this connection, according to Japanese Patent Laid-Open Nos. 2002-44704, 2002-33809, 2001-136248 and 2000-196718, besides such a first operating unit, a second operating unit is provided on an outer surface of the casing, thus enabling the folding cellular phone to be operated in a folded state. For example, the second operating unit is a side switch, a jog dial, a scroll button or the like. Similarly, also in the flip cellular phone, when the flip covers such a first operating unit provided on a casing thereof, a user cannot operate the operating unit. Therefore, Japanese Patent Laid-Open Nos. 2002-9922, 2000-270062 and 2001-292213 disclose the jog dial as the second operating unit.

However, it is easier to operate the second operating unit than the first operating unit. Therefore, there are increased possibilities that an operating error occurs and that another person than the user operates the second operating unit on purpose. In addition, in some cases, an operating unit generating an alarm signal is located as the second operating unit. Hence, for this second operating unit, desired is a form free from fear of the operating error, in which this second operating unit may hardly be operated even if it is operated by another person than the user.

### SUMMARY OF THE INVENTION

A mobile terminal device as an example of the present invention comprises an antenna portion, which includes a tip portion located outside a casing of the mobile terminal device and a switch unit controlling an operation of the mobile terminal device. The switch unit is operated by operating this tip portion, and thus the mobile terminal device can perform predetermined operations. The switch unit can include at least one of a depression switch and a rotation switch. Respective operation modes of the tip portion correspond to respective operations of the mobile terminal device. The operation modes of the tip portion, in which the mobile terminal device is operated, are changeable. The mobile terminal device can output an alarm signal in accordance with a predetermined operation mode of the tip portion. When the alarm signal is a radio wave signal, the mobile terminal device can transmit at least one of a predetermined message and a current position thereof to at least any of a police station and a rescue center. As forementioned above, the mobile terminal device described above can be operated easily and securely by the predetermined operations of the antenna portion. Therefore, the operation by another person and the operating error can be prevented.

### BRIEF DESCRIPTION OF THE DRAWINGS

The above and other objects, features and advantages of the present invention will become apparent from the following detailed description when taken with the accompanying drawings in which:

FIG. 1 is a block diagram of an example of a mobile terminal device of the present invention;

FIG. 2 is a perspective view of a folding mobile terminal device;

FIG. 3 is a cross-sectional view of an antenna portion;

FIG. 4 is a side view of an antenna tip portion;

FIG. 5 is a side view of another example of the antenna tip portion;

FIGS. 6A and 6B are perspective views of an example of a rotation switch;

FIG. 7 is a perspective view of another example of the rotation switch;

FIGS. 8A and 8B are perspective views of still another example of the rotation switch;

FIG. 9 is a perspective view of yet another example of the rotation switch;

FIG. 10 is a pattern diagram showing an example of an operation mode of the antenna tip portion;

FIG. 11 is a table showing an example of an operation menu of a cellular phone;

FIG. 12 is a flowchart of an operation example of the cellular phone; and

FIG. 13 is a flowchart of an example of an alarm operation of the cellular phone.

### DETAILED DESCRIPTION OF THE PREFERRED EMBODIMENTS

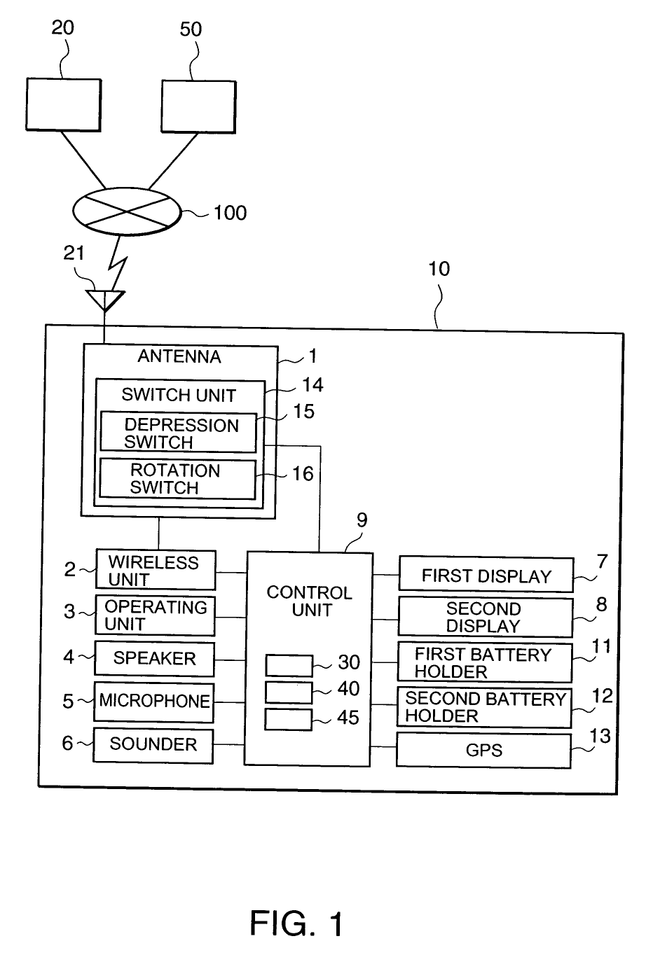

An example of a configuration of a mobile terminal device of the present invention will be described below. Referring to FIG. 1, the mobile terminal device 10 is connected to the other mobile terminal device 20 and the rescue center 50 through the public network 100. This mobile terminal device 10 includes the antenna portion 1, the wireless unit 2, the operating unit 3, the speaker 4, the microphone 5, the sounder 6, the first display unit 7, the second display unit 8, the first battery holder 11, the second battery holder 12, and the Global Positioning System (hereinafter abbreviated as GPS) 13. The antenna portion 1 includes the tip portion 21 and the switch unit 14, and the switch unit 14 has the depression switch 15 and the rotation switch 16. The GPS 13 generates position information of the mobile terminal device 10 and outputs the generated position information to the control unit 9. An example where the mobile terminal device is a folding cellular phone including first and second casings will be described. In this case, for example, the operating unit 3, the speaker 4, the microphone 5 and the first display unit 7 are arranged on an inner surface of the cellular phone, which cannot be viewed by a user when the cellular phone is folded. The sounder 6, the second display unit 8 and the first battery holder 11 are arranged on an outer surface of the cellular phone, which can be viewed by the user even when the cellular phone is folded. The antenna portion 1, the wireless unit 2, the control unit 9, the second battery holder 12 and the GPS 13 are arranged inside the casings. The antenna portion 1 is retractable and has the tip portion 21. A part of the tip portion 21 is always located outside the casing of the cellular phone.

When the folding cellular phone is folded, or when a flip of a flip cellular phone covers the operating unit 3, the user operates the tip portion 21. The depression switch 15 and the rotation switch 16 are operated by operating the tip portion 21. The control unit 9 controls the operation of the cellular phone in response to these operations of the switches. The cellular phone performs a variety of operations in accordance with the respective operation modes. It is possible to change the operation mode settings of the tip portion 21, each of which is prepared in order to allow the cellular phone to execute the predetermined operation. The cellular phone executes the predetermined operation by operating the antenna tip portion 21 always located outside the casing. Therefore, for the user, the cellular phone becomes easier to use. Because only the specific operation modes of the tip portion 21, which are set by the user, allow the cellular phone to operate, it is difficult for another person to operate the cellular phone. The operations of the cellular phone which are executed by operating the tip portion 21 include, for example, switch on and off of thebacklight of the second display unit 8 described above, a menu display on the second display unit 8 and the like. The cellular phone can output an alarm signal by operating the tip portion 21. As the alarm signal, the user can select at least one of a sound wave signal and a radio wave signal. In the case of selecting the radio wave signal, at least one of the rescue center 50 and a police station can receive this radio wave signal through the public network 100. The radio wave signal includes at least one of the current position of the cellular phone and the predetermined message.

The first battery holder 11 holds a first battery for enabling usual operations of the cellular phone to be executed. The first battery is easily detachable. The second battery holder 12 holds a second battery, and the second battery is usable as a power source when the first battery is lost from the holder 11 due to an accident and the like. The control unit 9 includes the operation table 30, the alarm mode setting table 40 and the phone directory table 45.

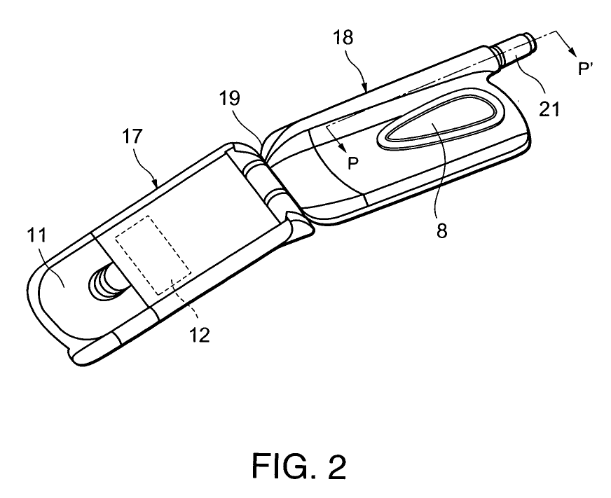

Referring to FIG. 2, the first and second casings 17 and 18 of the folding cellular phone are coupled together by the hinge portion 19. The first casing 17 includes the first battery holder 11 and the second battery holder 12. The second battery holder 12 is located inside the first casing 17 and cannot be easily detached therefrom. The second casing 18 includes the antenna portion 1 and the second display unit 8. The user can view the second display unit 8 even when the folding cellular phone is folded. The tip portion 21 of the antenna portion 1 is always located outside the second casing 18. The body of the antenna portion is retractable.

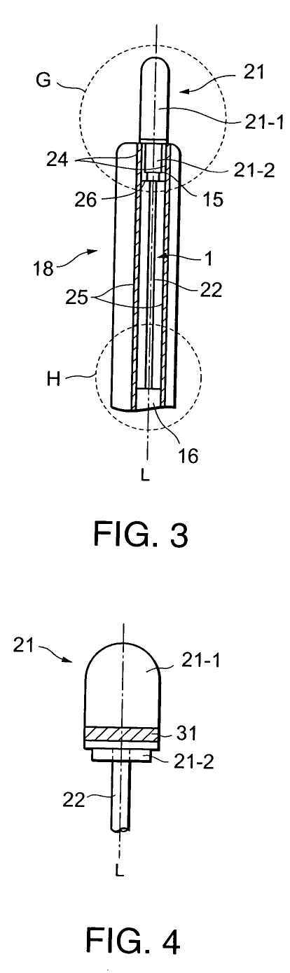

FIG. 3 shows a cross section of the antenna 1, which is cut along the line P-P′ in FIG. 2. The antenna tip portion 21 includes the first and second tip portions 21-1 and 21-2. The second tip portion 21-2 can be accommodated in the second casing 18. The tip portion 21 includes the depression switch 15. The retractable antenna rod 22 is connected to the tip portion 21. The rotation switch 16 is located on the lower portion of the antenna rod 22. The second tip portion 21-2 is accommodated in the antenna accommodation portion 24, and the antenna rod 22 is accommodated in the antenna accommodation portion 25. The partition plate 26 partitions these two accommodation portions.

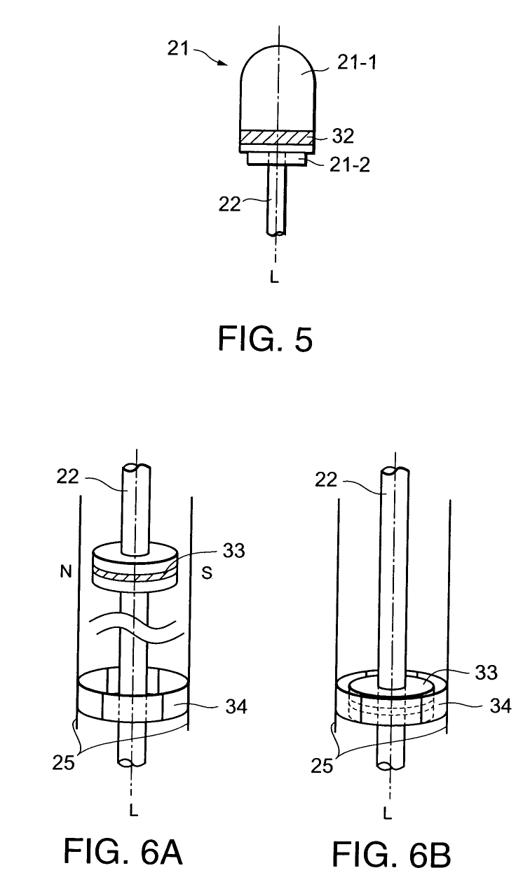

FIG. 4 shows an enlarged view of the region denoted by the reference symbol G in FIG. 3. The rubber portion 31 is interposed between the first and second tip portions 21-1 and 21-2. The depression switch 15 detects compression of the rubber portion 31, which is caused by the operation of the tip portion 21, and notifies a detection result to the control unit 9. Referring to FIG. 5, the spring portion 32 is interposed between the first and second tip portions 21-1 and 21-2. The depression switch 15 detects compression of the spring portion 32, which is caused by the operation of the tip portion 21, and notifies a detection result to the control unit 9.

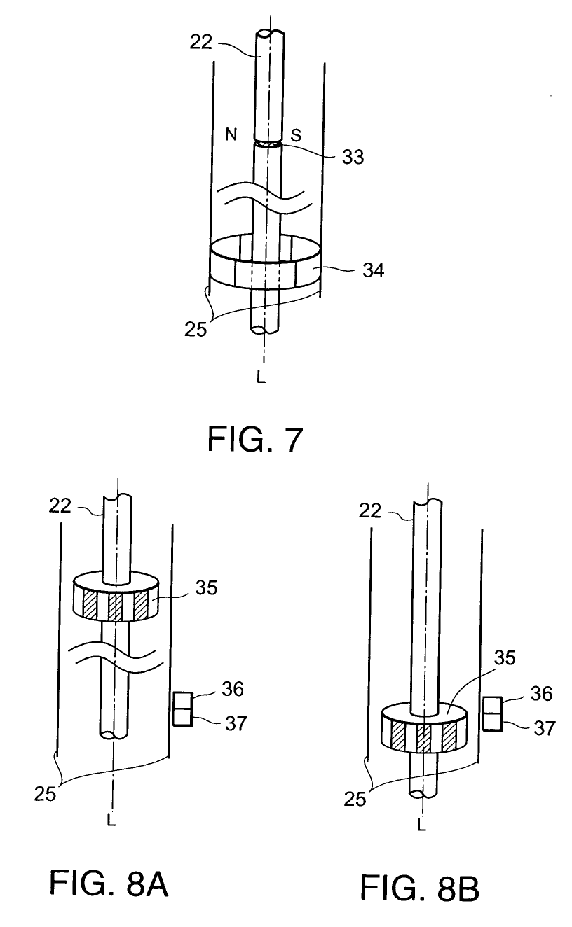

FIGS. 6A and 6B show enlarged views of the region denoted by the reference symbol H in FIG. 3. The magnetic rotation switch 16 of a specific example includes the permanent magnet 33 attached to the antenna rod 22, and the search coil 34 formed in the antenna accommodation portion 25. The permanent magnet 33 is disk-shaped and magnetized in a specific direction parallel to the disk surface. The search coil 34 is ring-shaped. When the antenna rod 22 is retracted as shown in FIG. 6B, the search coil 34 is located so as to be opposed to the permanent magnet 33. The search coil 34 detects that the permanent magnet 33 has rotated by a predetermined angle, and the magnetic rotation switch 16 notifies a detection result to the control unit 9. FIG. 7 shows an example where the permanent magnet 33 is unified with the antenna rod 22. In the magnetic rotation switch 16 described above, it is possible to invert the locating positions of the permanent magnet 33 and search coil 34 to each other. In this inverted arrangement, the permanent magnet 33 can have a ring shape. Alternatively, N pole magnet and S pole magnet can be arranged separately. FIGS. 8A and 8B show enlarged views of the region denoted by the reference symbol H in FIG. 3. The optical rotation switch 16 of a specific example includes the reflection plates 35 formed on an outer side surface of a disk attached to the antenna rod 22, and the LED 36 and the phototransistor 37, both of which are formed on the antenna accommodation portion 25. When the antenna rod 22 is retracted as shown in FIG. 8B, the LED 36 and the phototransistor 37 are located at positions opposite to those of the reflection plates 35. The reflection plates 35 are formed on the outer side surface of the disk at a predetermined interval. Regions between the respective reflection plates 35 do not reflect light very much. When the tip portion 21 rotates, the antenna rod 22 and the reflection plate 35 rotate around the center axis L. Light emitted from the LED 36 is reflected by the reflection plates 35. The phototransistor 37 detects the number of intense reflected light. Consequently, the phototransistor 37 detects the rotation angle of the tip portion 21, and notifies the detected rotation angle to the control unit 9.

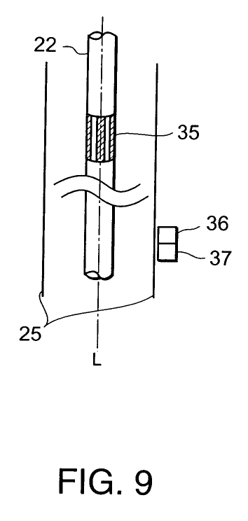

FIG. 9 shows an example where the reflection plates 35 are directly formed on the antenna rod 22. The location of the reflection plates 35 and the location of the LED 36 and phototransistor 37 may be inverted. The LED 36 and the phototransistor 37 can be arranged adjacent to each other. Alternatively, the LED 36 and the phototransistor 37 can be arranged so as to be opposed to each other. In this case, in place of the reflection plates 35, a plurality of slits are formed on a part of the antenna rod 22. These slits are formed on a path connecting the LED 36 and the phototransistor 37. The phototransistor 37 detects light which is emitted from the LED 36 and transmitted through the slits.

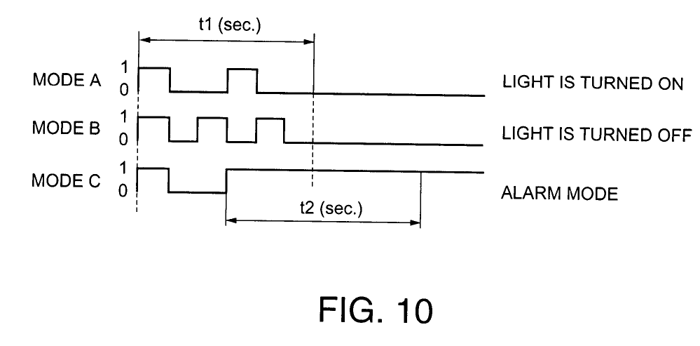

FIG. 10 shows a timing chart of examples of the operation modes of the depression switch 15. When the depression switch 15 is depressed, information “1” is notified to the control unit 9. When the depression switch 15 is not depressed, information “0” is notified to the control unit 9. The mode A is an operation mode of depressing the tip portion 21 twice within set time t1 (sec.). In this example, in the operation of the mode A, the backlight of the second display unit 8 is turned on. The mode B is an operation mode of depressing the tip portion 21 three times within the set time t1 (sec.). In this example, in the operation of the mode B, the backlight of the second display unit 8 is turned off. In the mode C, an alarm signal is issued. The mode C is an operation mode of depressing the tip portion 21 once and then continuing to depress the tip portion 21 for a time longer than set time t2 (sec.). These operation modes can be changed by the user.

The user can select at least one of a sound wave signal and a radio wave signal as the alarm signal. For the alarm signal, it is possible to create a format, in which the signal is initially a sound wave signal outputted from the sounder 6 and then changed to a radio wave signal after the elapse of a predetermined time, or in which the radio wave signal is superposed on the sound wave signal. The radio wave signal includes position information of the cellular phone from the GPS 13 and the phone number thereof. The user can stop the transmission of the alarm signal by entering a personal identification number to the operating unit 3.

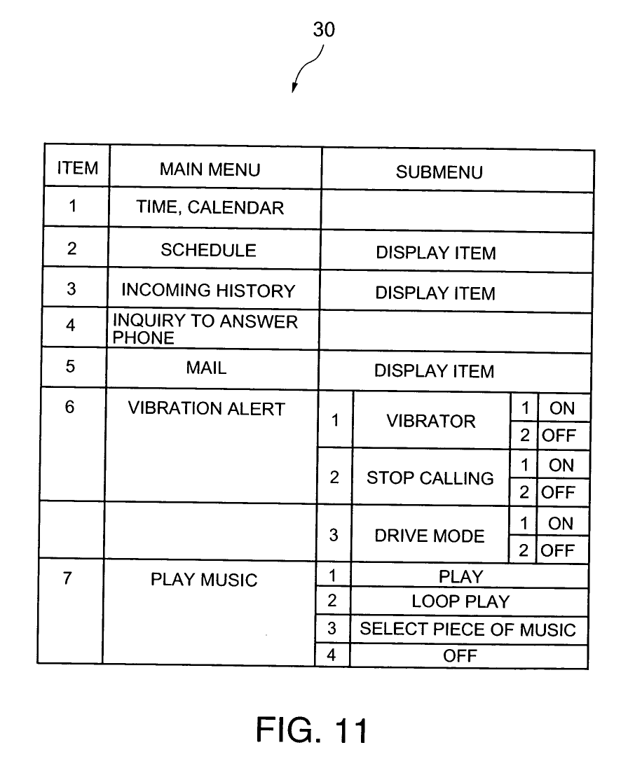

FIG. 11 shows an example of the operation table 30. For example, the cellular phone operates as follows by use of the operation table 30. In the case of receiving the mode A from the depression switch 15 (that is, the antenna tip portion 21), the control unit 9 turns on the backlight of the second display unit 8 and displays “TIME, CALENDAR” of the first item in the main menu of the operation table 30, which includes seven items. When the user rotates the antenna tip portion 21 by a predetermined angle, the rotation switch 16 is rotated in synchronization therewith. To the control unit 9, the rotation switch 16 sends information corresponding to the rotation angle. The control unit 9 displays a predetermined item in the main menu described above on the second display unit 8 based on the rotation angle. When the user enters the mode A from the depression switch 15 in the case where the item of “PLAY MUSIC” in the main menu is displayed on the second display unit 8, a submenu “PLAY” is displayed on the second display unit 8 and is executed. At this moment, a piece of predetermined music is outputted through sounder 6 for a preset time. When the user enters the mode A again from the depression switch 15, a submenu “LOOP PLAY” is displayed and executed. Moreover, when the user enters the mode B from the depression switch 15, the execution of the submenu is stopped, and the main menu “PLAY MUSIC” is displayed on the second display unit 8.

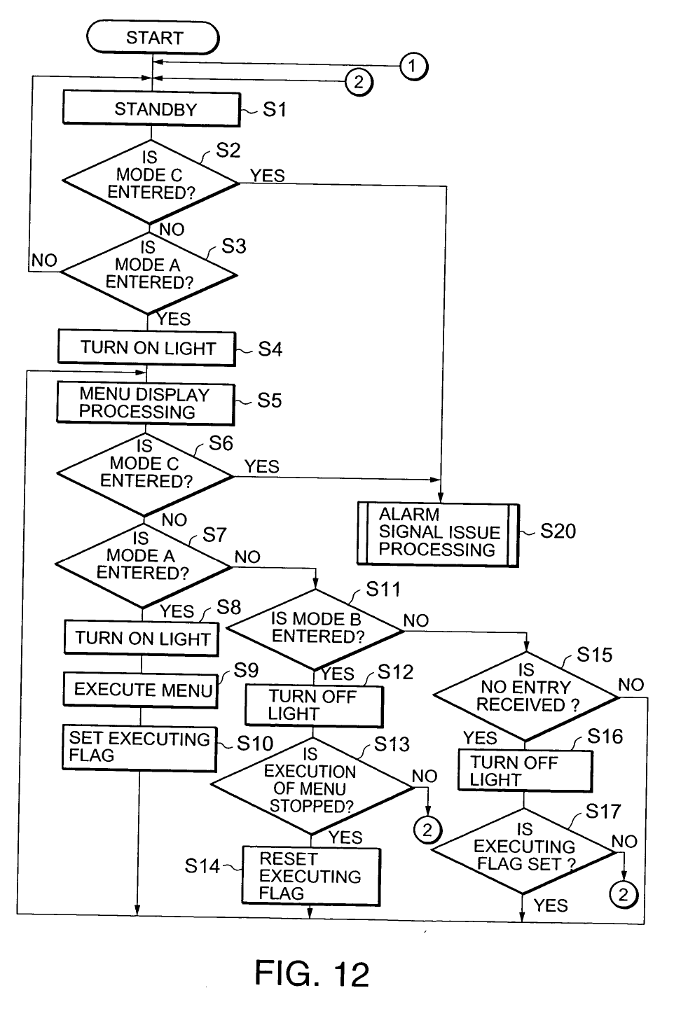

FIG. 12 shows a flowchart illustrating the operation of the cellular phone. First, the cellular phone is on standby (S1). When the user enters the mode A from the depression switch 15 (YES in S3), the control unit 9 turns on the backlight of the second display unit 8 (S4), and displays the menu (S5). For example, the main menu “TIME, CALENDAR” is displayed. In this case, the user rotates the antenna tip portion 21 (that is, the rotation switch 16), and thus making it possible to display a predetermined main menu. The case where the main menu “PLAY MUSIC” is displayed on the second display unit 8 will be described below. When the user enters the mode A from the depression switch 15 (S6), the control unit 9 turns on the backlight (S8), executes the submenu “PLAY,” and displays this submenu on the second display unit 8 (S9). When the submenu “PLAY” is under execution (when a piece of predetermined music is outputted through the sounder 6 for a preset time), the control unit 9 sets a “PLAY” executing flag representing that the submenu “PLAY” is being executed (S10). Then, the control unit 9 returns to the menu display processing (S5). After the execution of the submenu “PLAY” is terminated, the control unit 9 releases the “PLAY” executing flag described above.

When the mode B is entered from the depression switch 15 (S11) in the case where the control unit 9 returns to the menu display processing (S5) and the submenu “PLAY” is under execution, the control unit 9 turns off the backlight of the second display unit 8 (S12), and forcibly terminates the execution of the submenu “PLAY” (S13). Furthermore, the control unit 9 releases the “PLAY” executing flag (S14), and returns to the menu display processing (S5). When the mode B is entered from the depression switch 15 after the termination of the submenu “PLAY,” the control unit 9 turns off the backlight of the second display unit 8 (S12), displays the main menu “PLAY MUSIC” on the second display unit 8, and returns to the menu display processing (S5). When the mode B is entered from the depression switch 15 in the case where the main menu “PLAY MUSIC” is displayed on the second display unit 8, the control unit 9 returns the cellular phone on standby (S1).

When the control unit 9 receives no entry from the depression switch 15 or the rotation switch 16 for a time longer than a set time t3 (YES in S15), the control unit 9 turns off the backlight of the second display unit 8 (S16). When the “PLAY” executing flag is not set in the operation table 30, the control unit 9 returns the cellular phone on standby (S1). When the mode C is entered from the depression switch 15 during the standby (S1), the menu display processing (S5) or the execution of the menu, an alarm signal is issued (S20).

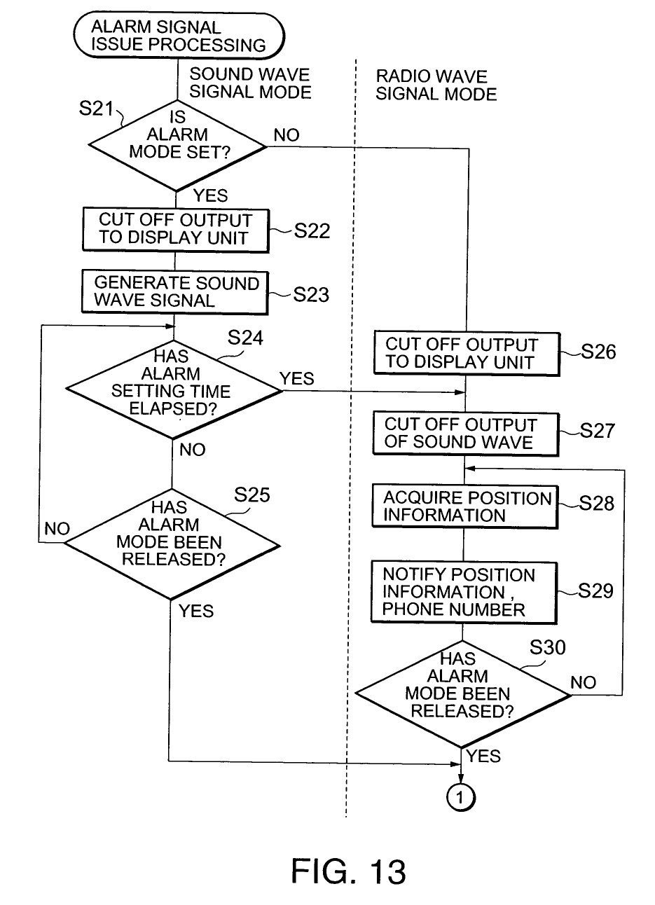

FIG. 13 shows a flowchart of the alarm signal issue processing (S20). The alarm mode setting table 40 is referred to. When a flag representing an alarm (sound wave signal) mode is set (YES in S21), the control unit 9 turns off the backlight of the second display unit 8 and turns off the display (S22). The control unit 9 allows the sounder 6 to output a sound wave signal at the maximum volume (S23). If an alarm setting time has not elapsed (NO in S24), the control unit 9 determines whether an alarm (sound wave signal) mode has been released (S25). If the alarm (sound wave signal) mode has not been released (NO in S25), the control unit 9 allows the sounder 6 to continue outputting the sound wave signal. If the sound wave signal mode has been released (YES in S25), the control unit 9 returns the cellular phone on standby (S1). If the alarm setting time has elapsed (YES in S24), the control unit 9 moves to a radio wave signal mode.

When the flag representing the sound wave signal mode is not set in the alarm mode setting table 40 (NO in S21), the control unit 9 directly issues a command of an operation according to an alarm (radio wave signal) mode. The control unit 9 turns off the backlight of the second display unit 8 and turns off the display (S22). Furthermore, the control unit 9 turns off an output to the sounder 6 (S27). If the alarm (radio wave signal) mode has not been released, the control unit 9 acquires the position information from the GPS 13 (S28). Then, the control unit 9 allows the cellular phone to transmit the alarm information including the position information and the phone number thereof to either or both of the police station and the rescue center 50 at every fixed interval (S29). If the alarm (radio wave signal) mode has been released (YES in S30), the control unit 9 returns the cellular phone on standby (S1). After the transmission of the radio wave signal, the user can stop the transmission anytime by entering a predetermined number to the operating unit 3. Even if the first battery is lost from the first battery holder when the alarm signal is issued, such an issue operation of the alarm signal continues by the second battery held in the second battery holder.

The above-described example is applied to the flip cellular phone and other various mobile terminal devices.

The mobile terminal device of the present invention is excellent in ease of operation. For example, in the folding cellular phone, necessary operations and the issue of the alarm signal can be performed while keeping the cellular phone folded.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the sprit and scope of the following claims.

What is claimed is:

1. A mobile terminal device having an antenna portion, wherein the antenna portion comprising:
a tip portion located outside a casing of the mobile terminal device; and
a switch unit controlling an operation of the mobile terminal device.

2. The mobile terminal device according to claim 1,
wherein the switch unit is operated by operating the tip portion, and the mobile terminal device performs a predetermined operation.

3. The mobile terminal device according to claim 2,
wherein the switch unit includes at least one of a depression switch and a rotation switch.

4. The mobile terminal device according to claim 3,
wherein the depression switch is operated by pressing a tip portion thereof, and
the rotation switch is operated by rotating a tip portion thereof.

5. The mobile terminal device according to claim 2,
wherein respective operation modes of the tip portion correspond to respective operations of the mobile terminal device.

6. The mobile terminal device according to claim 5,
wherein the operation modes of the tip portion, in which the mobile terminal device is operated, are changeable.

7. The mobile terminal device according to claim 5,
wherein the mobile terminal device outputs an alarm signal in accordance with a predetermined operation mode of the tip portion.

8. The mobile terminal device according to claim 7,
wherein the alarm signal is a sound wave signal.

9. The mobile terminal device according to claim 7,
wherein the alarm signal is a radio wave signal.

10. The mobile terminal device according to claim 9,
wherein the mobile terminal device sends an alarm signal including at least one of a current position of the mobile terminal device and a predetermined message to at least any of a police station and a rescue center.

11. The mobile terminal device according to claim 2, further comprising a display unit,
wherein the display unit displays an operation item of the mobile terminal device in accordance with a predetermined operation mode of the tip portion of the antenna portion.

12. The mobile terminal device according to claim 11,
wherein the mobile terminal device includes first and second casings connected to each other by a hinge portion, and
the display unit can be viewed from an outside in a state where the first and second casings are folded.

13. The mobile terminal device according to claim 1, further comprising: a first battery holder for a first battery and a second battery holder for a second battery,
wherein the mobile terminal device is operated by the second battery in a case where the first battery is lost.

14. The mobile terminal device according to claim 3,
wherein the rotation switch includes a permanent magnet magnetized in a predetermined direction, and a search coil.

15. The mobile terminal device according to claim 3,
wherein the rotation switch includes a reflection plate, a light-emitting element emitting light on to the reflection plate, and a photodetection element receiving reflected light from the reflection plate.
